(19) United States
(12) Patent Application Publication
(10) Pub. No.: US 2023/0256542 A1
(43) Pub. Date: Aug. 17, 2023

(54) METHOD OF MANUFACTURING JOINED MEMBER

(71) Applicant: HONDA MOTOR CO., LTD., Tokyo (JP)

(72) Inventors: Seiya OKAMURA, Saitama (JP); Masaaki FUJIMOTO, Saitama (JP)

(21) Appl. No.: 18/147,009

(22) Filed: Dec. 28, 2022

(30) Foreign Application Priority Data
Feb. 11, 2022 (CN) 202210129389.4

(51) Int. Cl. B23K 26/323; B23K 26/244; B23K 26/322; B23K 26/082

(52) U.S. Cl. CPC B23K 26/323; B23K 26/082; B23K 26/244; B23K 26/322; B23K 2103/20

(57) ABSTRACT

Provided is a method of manufacturing a joined member by joining a first metal member and a second metal member, the method including: melting an end portion on a joining side of the first metal member, while the first metal member is disposed adjacent to at least a portion of the second metal member, by irradiating the heat source while scanning, the heat source irradiated to the end portion on the joining side of the first metal member has a central portion and a peripheral portion located at a periphery of the central portion and having energy intensity lower than that of the central portion, and in the peripheral portion, a length in a scanning direction of the heat source is longer than a length in a direction perpendicular or substantially perpendicular to the scanning direction of the heat source.

This application is based on and claims the benefit of priority from Chinese Patent Application No. CN202210129389.4, filed on 11 Feb. 2022, the content of which is incorporated herein by reference.

### BACKGROUND OF THE INVENTION

### Field of the Invention

The present invention relates to a method of manufacturing a joined member.

### Related Art

Conventionally, a reduction in the weight of a vehicle body has been desired because it contributes to an improvement in the fuel consumption of the vehicle. On the other hand, a joined member obtained by welding metal members made of different materials has an excellent balance between rigidity and light weight and, therefore, is applied to vehicle components.

Japanese Unexamined Patent Application, Publication Nos. 2005-169395 and H8-206650 describe that, when a metal member is melted, a laser beam having a lower energy intensity in a peripheral portion than in a central portion is irradiated.
Patent Document 1: Japanese Unexamined Patent Application, Publication No. 2005-165395
Patent Document 2: Japanese Unexamined Patent Application, Publication No. H8-206650

### SUMMARY OF THE INVENTION

However, when scanning a laser beam, since the temperature of the metal member rapidly changes, cracks are generated in the joined member or air bubbles remain therein, and the strength of the joined member decreases.

An object of the present invention is to provide a method of manufacturing a joined member capable of improving strength.

One aspect of the present invention is directed to a method of manufacturing a joined member by joining a first metal member and a second metal member, the method including: irradiating and melting an end portion on a joining side of the first metal member, while the first metal member is disposed adjacent to at least a portion of the second metal member, by irradiating a heat source while scanning, in which the heat source irradiated to the end portion on the joining side of the first metal member has a central portion and a peripheral portion located at a periphery of the central portion and having energy intensity lower than that of the central portion, and in the peripheral portion, a length in a scanning direction of the heat source is longer than a length in a direction perpendicular or substantially perpendicular to the scanning direction of the heat source.

the second metal member may be an alloyed zinc-plated steel sheet.

The first metal member may be an aluminum alloy plate.

As a scanning speed of the heat source is higher, the length of the peripheral portion in the scanning direction of the heat source may be set to become longer.

The first metal member may be in a plate shape, and may have a region opposed to the second member without contacting the second member at the end portion on the joining side of the first member, and the peripheral portion may be also irradiated to the second metal member.

According to an embodiment of the present invention, it is possible to provide a method of manufacturing a joined member capable of improving strength.

### BRIEF DESCRIPTION OF THE DRAWINGS

FIGS. 1A and 1B are each a schematic view showing an example of a method of manufacturing a joined member of an embodiment of the present embodiment. FIG. 2 is a perspective view showing a method of manufacturing the joined member of FIGS. 1A and 1B. FIG. 3 is a view showing an example of a laser welding machine used in the method of manufacturing the joined member of FIGS. 1A and 1B. FIG. 4 is a view showing the structure of a laser head of FIG. 3.

### DETAILED DESCRIPTION OF THE INVENTION

Hereinafter, embodiments of the present invention will be described with reference to the accompanying drawings.

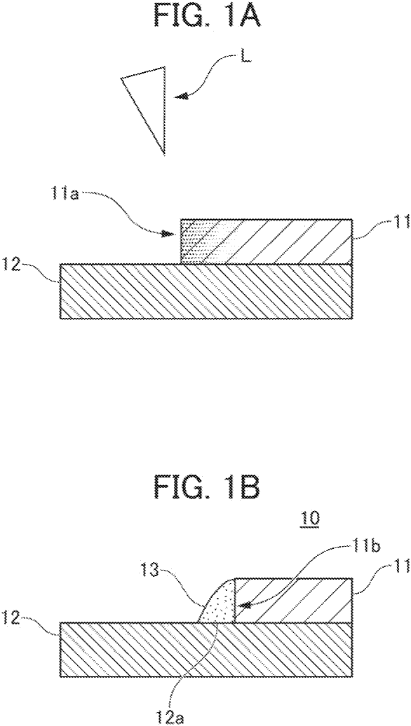

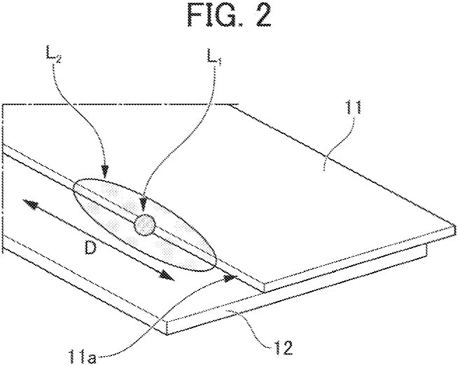

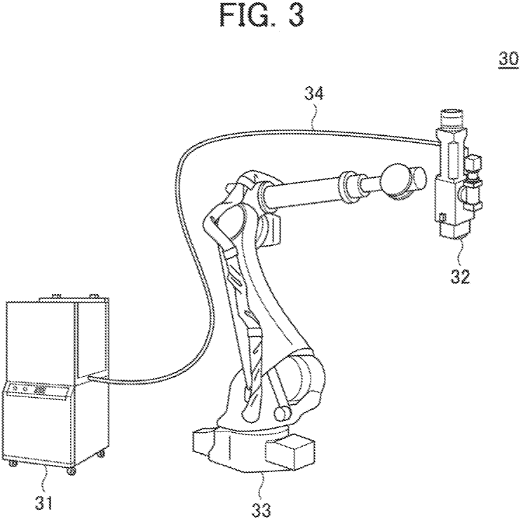

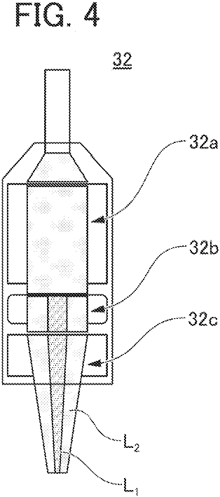

FIGS. 1 and 2 each show an example of a method of manufacturing a joined member of an embodiment of the present invention.

The method of manufacturing the joined member 10 is a method of manufacturing the joined member 10 by joining a first metal plate 11 serving as a first metal member and a second metal plate 12 serving as a second metal member. Specifically, in a state in which the first metal plate 11 is disposed so as to be adjacent to a portion of the second metal plate 12, the first metal plate 11 and the second metal plate 12 are joined to each other via a joining portion 13 (refer to FIG. 1B) by irradiating and melting an end portion 11a on a joining side of the first metal plate 11 while scanning a laser beam L (refer to FIG. 1A).

Here, the laser beam L irradiated to the end portion 11a on the joining side of the first metal plate 11 has a circular central portion L₁ and an elliptical peripheral portion L₂ located at the periphery of the central portion L₁ and having energy intensity lower than that of the central portion L₁. Furthermore, in the peripheral portion L₂, the length in the scanning direction D of the laser beam L is longer than the length in the direction perpendicular to the scanning direction D of the laser beam L, i.e., the length in the thickness direction of the first metal plate 11. Therefore, by irradiating the end portion 11a on the joining side of the first metal plate 11 with the peripheral portion L₂, the central portion L₁, and the peripheral portion L₂ of the laser beam L sequentially, a rapid temperature change of the first metal plate 11 is suppressed. As a result, the generation of cracks and the remnants of air bubbles in the first metal plate 11 are suppressed, and the strength of the joined member 10 is improved. Furthermore, since the peripheral portion L₂ of the laser beam L is irradiated onto the surface of the second metal plate 12, the impurity component is removed even if the impurity component such as the oil component and the plating component remains. Furthermore, since it is possible for the peripheral portion L₂ to have a narrower irradiation range than a concentric circle whose diameter is the length in the scanning direction D, it is possible to reduce the energy consumption. On the contrary, when the length of the peripheral portion L₂ in the scanning direction D of the laser beam L is equal to or less than the length in the direction perpendicular to the scanning direction D of the laser beam L, the temperature of the first metal plate 11 rapidly changes.

The scanning of the laser beam L may be continuous or intermittent.

It is preferable that, as the scanning speed of the laser beam L is higher, the length of the peripheral portion L₂ in the scanning direction of the laser beam L is set to become longer. As a result, it is possible to sufficiently secure a time period during which the temperature is gradually raised and lowered in the peripheral portion L₂, and the generation of cracks and the remnants of air bubbles in the first metal plate 11 are suppressed.

In addition, the length of the peripheral portion L₂ in the scanning direction of the laser beam L may be adjusted manually or by computer control.

The first metal plate 11 may have a region opposed to the second metal plate 12 without contacting the second metal plate 12 at the end portion 11a on the joining side thereof, and the peripheral portion L₂ may also be irradiated to the second metal plate 12. In this case, since the peripheral portion L₂ is incident on the interval between the first metal plate 11 and the second metal plate 12, it is possible effectively increase the temperature of the second metal plate 12 regardless of the heat conduction from the first metal plate 11. As a result, it is possible to improve the bond strength of the joined member 10.

In the joined member 10, the second metal plate 12 and the first metal plate 11 which is in contact with a portion of the second metal plate 12 are joined via the joining portion 13. At this time, an end surface 11b on the joining side of the first metal plate 11 is in contact with the joining portion 13. In addition, a portion 12a of the surface of the second metal plate 12 which comes into contact with the first metal plate 11 is contacting the joining portion 13.

Here, the material of the joining portion 13 is substantially the same as that of the first metal plate 11. Therefore, the bond strength of the joined member 10 is improved.

As used herein, substantially the same material indicates that the materials are the same except for impurities that are unavoidably contaminated.

In the joined member 10, the first metal plate 11 and the second metal plate 12 are used as the first metal member and the second metal member, respectively. However, the shapes of the first metal member and the second metal member are not particularly limited.

The application of the joined member of the present embodiment is not particularly limited, and examples thereof include vehicle components. Among them, an outer plate portion of a vehicle body, a connecting portion (hemming portion) between a hood skin and a frame, a connecting portion between a skin such as a door and a frame, a connecting portion between an under floor panel and a frame member, a connecting portion of a battery box, and the like are preferable. Since the joined member of the present embodiment improves the liquid-tightness as well by joining, the joined member is preferably applied to these joining portions.

Examples of the second metal plate 12 include, but are not limited to, a non-plated steel plate, a molten zinc plated steel plate, an alloyed zinc plated steel plate, and an Al-Si plated steel plate. Among them, alloyed zinc-plated steel sheets are preferable. With such a configuration, the generation of air bubbles due to boiling of zinc is effectively suppressed, and bond strength of the joined member 10 is improved.

Although the thickness of the second metal plate 12 is not particularly limited, it is, for example, 0.5 mm or more and 3.0 mm or less.

Although the first metal plate 11 is not particularly limited, examples thereof include an aluminum plate and an aluminum alloy plate.

When the second metal plate 12 is an alloyed zinc-plated steel plate, the first metal plate 11 is preferably an aluminum alloy plate. With such a configuration, wettability of the molten aluminum with respect to the molten zinc is improved, and the joining portion 13 is formed over a wide range. Furthermore, the generation of the intermetallic compound is suppressed, and the joining strength of the joined member 10 is improved.

Examples of the aluminum alloy of the aluminum alloy plate include an Al-Mn alloy, an Al-Mg alloy, an Al-Mg-Si alloy, an Al-Cu alloy, an Al-Zn-Mg alloy, and an Al-Si alloy.

Although the thickness of the first metal plate 11 is not particularly limited, it is, for example, 0.5 mm or more and 5.0 mm or less.

The first metal plate 11 and the second metal plate 12 may be made of the same kind of material. In this case, the first metal plate 11 and the second metal plate 1.2 may be aluminum (alloy) plates or steel plates.

FIG. 3 shows an example of a laser welding machine used in the method of manufacturing the joined member 10.

The laser welding machine 30 includes an oscillator 31 that generates a laser beam L, a laser head 32 that irradiates the laser beam L generated by the oscillator 31, and a robot 33 that operates the laser head 32. Here, the oscillator 31 and the laser head 32 are connected via an optical fiber 34.

The oscillator 31 is not particularly limited as long as the generated laser beam L can be transmitted by an optical fiber, and examples thereof include a fiber laser, a diode laser, and a disc laser.

The center wavelength, output, and the like of the laser beam L can be appropriately set according to the manufacturing conditions (for example, material, thickness, and the like) of the joined member 10.

Although the laser head 32 is not particularly limited, examples thereof include a fixed optical head, a variable optical head, beam shaping (single beam, twin beam, or the like) by a diffractive optical element (DOE), and a galvano head.

The laser head 32 includes a collimator 32a for shaping the laser beam L generated by the oscillator 31, a homogenizer 32b for branching the laser beam L shaped by the collimator 32a into a central portion L₁ and a peripheral portion L₂, and a focus lens 32c for focusing the central portion L₁ and the peripheral portion L₂ of the laser beam L branched by the homogenizer 32b (see FIG. 4).

Although the robot 33 is not particularly limited, examples thereof include industrial general-purpose robots.

The portable weight, movable range, accuracy, and the like of the robot 33 are not particularly limited.

Although embodiments of the present invention have been described above, the present invention is not limited to the above-described embodiments, and the above-described embodiments may be appropriately modified within the scope of the present invention.

### EXPLANATION OF REFERENCE NUMERALS

10 joined member
11 first metal plate
11a end portion
11b end surface
12 second metal plate
12a portion of surface
13 joining portion
30 laser welding machine
31 oscillator
32 laser head
32a collimator
32b homogenizer
32c focus lens
33 robot
34 optical fiber
D scanning direction
L laser
L₁ central portion
L₂ peripheral portion

What is claimed is:

1. A method of manufacturing a joined member by joining a first metal member and a second metal member, the method comprising:
melting an end portion on a joining side of the first metal member, while the first metal member is disposed adjacent to at least a portion of the second metal member, by irradiating while scanning a heat source,
wherein the heat source irradiated to the end portion on the joining side of the first metal member has a central portion and a peripheral portion located at a periphery of the central portion and having energy intensity lower than that of the central portion, and
in the peripheral portion, a length in a scanning direction of the heat source is longer than a length in a direction perpendicular or substantially perpendicular to the scanning direction of the heat source.

2. The method of manufacturing a joined member according to claim 1, wherein the second metal member is an alloyed zinc-plated steel sheet.

3. The method of manufacturing a joined member according to claim 2, wherein the first metal member is an aluminum alloy plate.

4. The method of manufacturing a joined member according to claim 1, wherein, as a scanning speed of the heat source is higher, the length of the peripheral portion in the scanning direction of the heat source is set to become longer.

5. The method of manufacturing a joined member according to claim 1, wherein
the first metal member is in a plate shape, and has a region opposed to the second member without contacting the second member at the end portion on the joining side of the first member, and
the peripheral portion is also irradiated to the second metal member.
